(19) United States
(12) Patent Application Publication
(10) Pub. No.: US 2020/0272222 A1
(43) Pub. Date: Aug. 27, 2020

(54) CONTENT SEARCH AND PACING CONFIGURATION

(71) Applicant: THOMSON LICENSING, issy-les-Moulineaux (FR)

(72) Inventors: Naveen GOELA, Berkeley, CA (US); Kent LYONS, San Jose, CA (US); Snigdha PANIGRAHI, Stanford, CA (US); Jean C. BOLOT, Los Altos, CA (US); Amit DATTA, Pittsburgh, PA (US); Caroline HANSSON, Oerebro (SE); Wenling SHANG, Ann Arbor, MI (US); Rashish TANDON, Austin, TX (US)

(21) Appl. No.: 16/066,135

(22) PCT Filed: Dec. 30, 2015
(86) PCT No.: PCT/US2015/068058

§ 371 Date: Jun. 26, 2018

(51) Int. Cl. G06F 3/01; G06F 3/03; G06F 1/16; G06K 9/00

(52) U.S. Cl. CPC G06F 3/011; G06K 9/00335; G06F 1/163; G06F 3/0304

(57) ABSTRACT

A smart wearable apparatus (102) includes a processor and a memory having a set of instructions that when executed by the processor causes the smart wearable apparatus to receive activity sensor data of an activity performed by a user. Further, the smart wearable apparatus is caused to send the activity sensor data to a content selection device (103) that selects content that is matched to the activity performed by the user so that the content is played in synchronization with the activity. Further, a process receives activity sensor data performed by a user. The process also sends the activity sensor data to a content selection device (103) that selects content that is matched to the activity performed by the user so that the content is played in synchronization with the activity.

### BACKGROUND

### 1. Field

This disclosure generally relates to the field of computing systems. More particularly, the disclosure relates to smart wearable devices and content playback devices.

### 2. General Background

Various online video services are utilized by users to view and/or listen to content. For example, online tutorials such as cooking lessons, music tutorials, dance instructional videos, etc. are popular amongst many users. Such tutorials are often utilized by such users as a learning mechanism. For instance, users may utilize such tutorials to learn a new hobby, expand their knowledge in a particular area of interest, etc.

### SUMMARY

A smart wearable apparatus includes a processor and a memory having a set of instructions that when executed by the processor causes the smart wearable apparatus to receive activity sensor data of an activity performed by a user. Further, the smart wearable apparatus is caused to send the activity sensor data to a content selection device that selects content that is matched to the activity performed by the user so that the content is played in synchronization with the activity.

Further, a process receives activity sensor data of an activity performed by a user. The process also sends the activity sensor data to a content selection device that selects content that is matched to the activity performed by the user so that the content is played in synchronization with the activity.

In addition, a content selection device includes a processor and a memory having a set of instructions that when executed by the processor causes the content selection device to receive, from a smart wearable device, activity sensor data of an activity performed by a user. Further, the content selection device is caused to select content that is matched to the activity performed by the user so that the content is played in synchronization with the activity.

A process also receives, from a smart wearable device, activity sensor data of an activity performed by a user. Further, the process selects content that is matched to the activity performed by the user so that the content is played in synchronization with the activity.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a content search and pacing configuration.

FIG. 2 illustrates the internal components of a content selection device.

FIG. 3 illustrates an example of a timeline of a tutorial.

FIG. 4 illustrates a process that is utilized by a smart wearable device to obtain data.

FIG. 5 illustrates a process that is utilized by a content selection device to select content.

### DETAILED DESCRIPTION

A configuration for content searching and pacing with a smart wearable device is provided. The configuration automatically searches for content, e.g., video, audio, images, text, etc., for a user based upon an activity being performed by that user without that user having to perform a manual search. In contrast with current online tutorials that necessitate a user manually searching for an online tutorial during an activity, the configuration automatically searches for and provides pertinent content to a user during the activity in a synchronized manner. For example, a typical tutorial video may have many portions that are not pertinent to a current user activity. In contrast with previous systems that required that the user be interrupted during the activity to find the pertinent segments, the configuration searches for segments of tutorial videos that are pertinent to the current user activity.

Further, the configuration synchronizes playback of the pertinent segments based upon particular actions of a user. For instance, the configuration may find pertinent segments from a particular tutorial to playback in a synchronized manner with the current activity of the user. As an example, the segments may be found via a search through a large and efficiently indexed content database of both relevant and irrelevant data. The configuration may also find pertinent segments from a variety of different tutorials and organize playback of the segments in a sequence performed by the user during the activity. The configuration may change content segments, ignore content segments, etc. as the user proceeds through a sequence of a particular activity to assist the user in an optimal manner. As a result, the user is able to obtain content for a smooth learning experience rather than a disruptive learning experience that necessitates the user stopping the activity being performed to perform searches for online content. In addition, the synchronization may involve a display of content which is matched and personalized to the user.

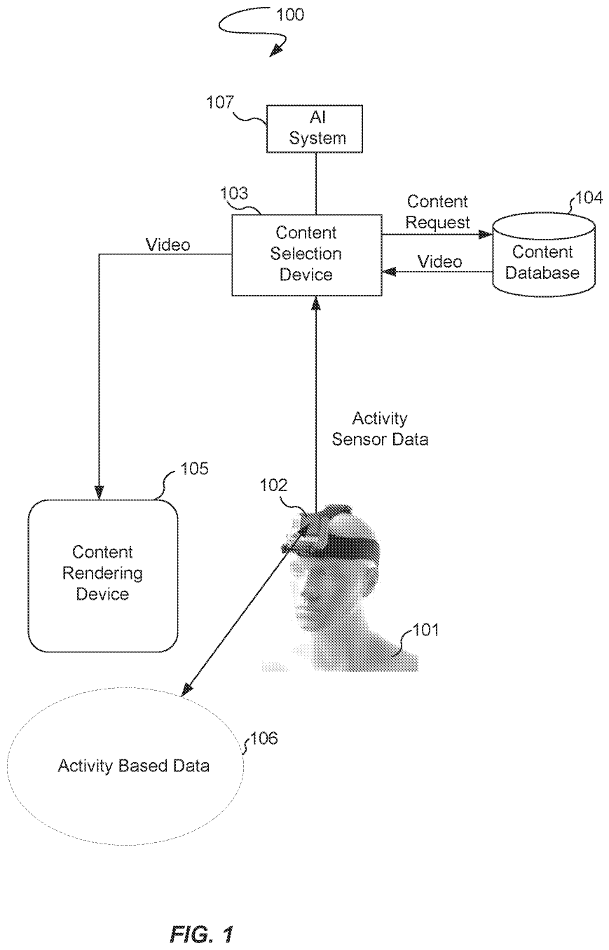

FIG. 1 illustrates a content search and pacing configuration 100. The content search and pacing configuration 100 includes a smart wearable device 102 that is worn by a user 101, a content selection device 103, a content database 104, and a content rendering device 105. Although the smart wearable device 102, the content selection device 103, and the content rendering device 105 are illustrated as distinct devices for ease of illustration, a single device or multiple devices may perform the corresponding functionality of the smart wearable device 102, the content selection device 103, and the content rendering device 105. A single device or multiple devices may also include as components some or all of the smart wearable device 102, the content selection device 103, and the content rendering device 105.

The smart wearable device 102, e.g., wearable image capture device, activity tracker, smart watch, smart glasses, a general activity sensor, etc., may be positioned on the user 101 to capture images during an activity performed by the user 101. For ease of illustration, the smart wearable device 102 is illustrated as a head mounted image capture device. The smart wearable device 102 may capture images of activity sensor data 106. As examples, the activity sensor data 106 may include activity-based imagery, accelerometer data, depth maps, haptic touch feedback data motion sensor data, infrared or heat sensor data, gesture-recognition sensor data, etc.

The smart wearable device 102 is utilized to detect certain user actions that may then be classified as corresponding to a particular aspect of a user activity. For example, the smart wearable device 102 may be utilized to detect motion of the hands of the user 101 in the activity sensor data 106 to effectively classify the user activity as a particular cooking activity. As another example, the smart wearable device 102 may be utilized to classify the state of the user activity, e.g., what food is being cooked and where the user 101 is in the process of cooking that particular food.

The smart wearable device 102 may be configured to automatically detect or sense user actions in an autonomous manner. For instance, the smart wearable device 102 may periodically capture images according to a predefined time interval, e.g., every five seconds the smart wearable device 102 performs an image capture. The smart wearable device 102 may also track the activity of the user 101 via various sensors, e.g., accelerometers, altimeters, etc. The smart wearable device 102 may also capture audio of the user 101 during the user activity and convert the audio to text for analysis of words spoken by the user 101 during the user activity. Therefore, the smart wearable device 102 may include a variety of components, e.g., image capture device, wireless sensors, GPS sensor, motion sensors, depth sensors, gyroscope sensor, etc., to obtain data that describes the state of the user 101 and/or other users or objects within the activity sensor data 106.

The detection and/or sensing functions of the smart wearable device 102 may also be performed by a device other than a wearable device. For example, an image capture device may be mounted to a wall in a kitchen rather than being positioned on the user 101. Further, the sensing may be performed through multiple distributed sensors.

Although one smart wearable device 102 is illustrated in FIG. 1, multiple smart wearable devices 102 may be utilized to gather sensing data. Further, the sensing data may be gathered from a combination of one or more smart wearable devices 102 and one or more devices other than smart wearable devices.

The content selection device 103 receives the activity sensor data from the smart wearable device 102. The content selection device 103 performs a matching process to match the state of the user 101 in the user activity with content. For example, the content selection device 103 may analyze image data from pictures received as part of the activity sensor data. The content selection device 103 may then perform a search of the content database 104 for content that matches the activity sensor data. For example, the content selection device 103 may perform an image to image comparison between an image found in the activity sensor data and the content database 104. In addition, the content selection device 103 may extract specialized features from the images and perform fast and efficient matching of features with reduced complexity. As a result, the content selection device 103 is able to obtain content not only pertinent to the particular user activity, but also pertinent to the state of that user activity. For instance, the content selection device 103 may receive an image from the smart wearable device 102 depicting a cracked egg. Therefore, the content selection device 103 is able to find not only content that is pertinent to cooking an egg, but also content that is particular to the portion of the cooking activity involving a cracked egg. As another example, the content selection device is able to search not only for a yoga tutorial, but also video content for a particular yoga pose that a user is performing during a yoga activity. As a result, the user is able to automatically receive content in real time based upon a current state of the user activity rather than an abundance of video content that is generically pertinent to a user activity, but not particular pertinent to the current state of that user activity.

Other types of data may be captured and utilized for analysis to classify the state of the user activity. For example, wearable speech-to-text data, video subtitle data, metadata such as tags added by a content producer or previous viewers, etc. may be captured through various smart wearable devices 102 for analysis by the content selection device 103.

The matching process may be performed according to a similarity index. In other words, a similarity index may be utilized as a predefined criterion for determining whether or not a content segment found in the content database 104 is deemed a match for the activity based imagery data. The matching process may also cache and save popular activities which are preferred by a particular user. For example, the user 101 may have a preference for cooking and/or hiking. The matching process is then able to obtain results faster by learning the preferred activity domains of the user 101 over time. The content selection device 103 may be a computing device, e.g., a personal computer, laptop computer, smartphone, smartwatch, tablet device, other type of mobile computing device, etc. In various embodiments, the content selection device 103 communicates with the content database 104 via a network configuration, e.g., cloud infrastructure, to request and receive content. For instance, the content database 104 may be in operable communication with a server computing device to and from which the content selection device 103 establishes communication. The content selection device 103 may utilize a search engine to search the content database for the content. The content selection device 103 may then perform the matching process on the search results. The server computing device corresponding to the content database 104 may also perform the matching process and/or machine learning functionality. The server computing device may then send the resulting content to the content selection device 103.

The content selection device 103 also performs pacing for the selected content segment to synchronize the current user activity with the particular content segment received from the content database 104 as a result of the matching process. The content selection device 103 assesses whether or not to play received content, skip received content, switch to different content, and/or provide recommendations for content. For instance, the content selection device 103 may utilize an artificial intelligence (“AI”) system 107 for such assessments. The AI system 107 may be in operable communication with the content selection device 103 or may be integrated as a part of the content selection device 103. The AI system 107 may determine that the user 101 is not progressing through the user activity at a fast enough pace, e.g., as determined by a predetermined time threshold, and play the received content to assist the user 101 obtain progress. The AI system 107 may also determine that the user 101 is progressing through the user activity at faster than normal pace, e.g., as determined by the predetermined time threshold, and skip the received content. The AI system 107 may also switch to different content in synchronization with the user activity. If the AI system 107 determines that other possible content may supplement or modify the user activity in a manner that may be of interest to the user 101, the AI system 107 may provide content recommendations to the user 101 based upon supplemental searches requested by the AI system 107. For example, the AI system 107 may recommend additional content if the state of the user 101 in the user activity is not keeping pace with the tutorial in the selected content as determined by the smart wearable device 102.

Further, the AI system 107 may perform machine learning to learn what the user 101 and/or other users deem to be helpful content selections. For example, the AI system 107 can sense, based upon reactions from the user 101, whether or not the selected content was helpful to obtaining progress through the activity by measuring an improvement or a lack of improvement to the pace at which the user 101 is performing the user activity. As a result, the AI system 107 may learn which content segments were or were not helpful for particular user activities so that the AI system 107 may utilizes or not utilize such content segments for content selection in subsequent user activities. The AI system 107 may also adjust the similarity index based upon such data. For example, the AI system 107 may determine that the similarity index has to have a higher similarity threshold or a lower similarity threshold to be deemed a match for content selection.

Further, the AI system 107 may utilize various inputs that the user provides to the smart wearable device 102 to assess if content should or should not be played. For example, the user 101 may activate buttons on the smart wearable device 102 to indicate a particular portion of the activity that is of particular interest to the user 101, e.g., the user 101 activating an image capture button during a particular pose. The AI system 107 is then able to determine that the particular portion of the user activity is a portion for which a corresponding selected content should not be skipped during the user activity.

In addition, the AI system 107 and corresponding machine learning code may be run on a distinct server from the smart wearable device 102, on the smart wearable device 102, on the content selection device 103, or on the content rendering device 105. The corresponding machine learning code may include functionality for synchronizing content for the preferences of the user, i.e., personalized content, and learning the preferences, pace, and common activity domains of the user 101 to aid in the matching of synchronized content from the database 104.

The content selection device 103 may have a media player stored thereon for providing commands for playing the selected content. The commands may be determined by the AI system 107. For example, the AI system 107 may analyze the state of the user 101 in the current user activity based upon data received from the smart wearable device 102 to determine that the user 101 has taken a break from the current user activity to have a telephone conversation. The AI system 107 may then generate a pause command that pauses play of the selected content. The AI system 107 may then generate a resume command that resumes play of the selected content after the AI system 107 determines that the user 101 is off of the telephone and resuming the current user activity. The AI system 107 may also analyze various activity based data, e.g., audio, video, user inputs, etc. to determine if a rewind command or a fast forward command should be performed. For example, the smart wearable device 103 may detect that the user 101 has discarded a cracked egg and obtain a new egg. The AI system 107 may then determine that a rewind command of the current selected content should be performed so that the user 101 is able to render the selected content again to perform cracking of the new egg. The AI system 107 may generate a fast forward command or skip command if the smart wearable device 103 provides data to the AI system 107 indicating that the user 101 has completed the action for the selected content.

The selected content can be played on a content rendering device 105. The user 101 can thereby play the selected content during performance of the user activity. The content rendering device 105 may be a television, a display screen of the content selection device 103, a display screen in operable communication with the smart wearable device 102, a hologram generation device, an audio listening device, etc. For example, the user 101 may view a video display on smart glasses or a smart watch so that the user 101 is able to continue performing the activity while receiving synchronized video. The AI system 107 may also be utilized to adjust the resolution of a video. For example, a smart video device can play security footage from a security camera at a low resolution. The AI system 107 may determine the occurrence of a suspicious event based upon activity based data, e.g., video, audio, etc., received from the smart wearable device 102. The AI system 107 may then adjust the resolution of the video to a higher quality based upon such determination. The AI system 107 may also wait for a verification input received from the user 101 via the smart wearable device 102 before adjusting the resolution.

In various embodiments, the content search and pacing configuration 100 searches for and synchronizes content segments that are the same type as data obtained by the smart wearable device 102. For example, the content search and pacing configuration 100 may obtain content data from the smart wearable device 102 and search for content segments. Further, in various embodiments, the content search and pacing configuration 100 searches for and synchronizes content segments that are a different type of data than that obtained by the smart wearable device 102. For example, the content search and pacing configuration 100 may obtain image data from the smart wearable device 102 and search for audio content segments.

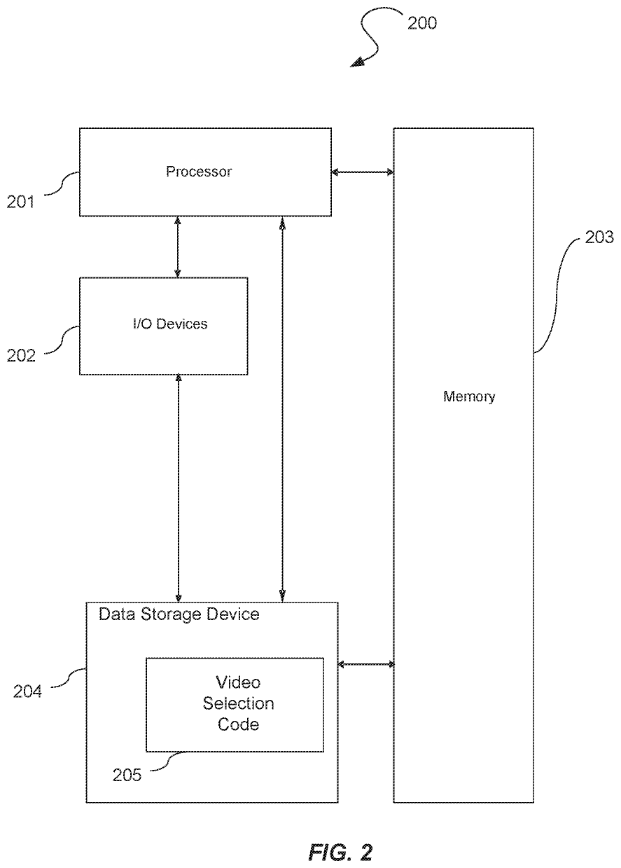

FIG. 2 illustrates the internal components 200 of the content selection device 103. The content selection device 103 comprises a processor 201, various input/output devices 202, e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device such as a keyboard, a keypad, a mouse, and the like, or a microphone for capturing speech commands, a memory 203, e.g., random access memory (“RAM”) and/or read only memory (“ROM”), a data storage device 204, and content selection code 205.

The processor 201 may be a specialized processor that is specifically configured to execute the content selection code 205 to perform the matching process to determine a content segment that matches the activity sensor data received from the smart wearable device 102. Therefore, the processor 201 improves the functioning of a computer by selecting content that is synchronized with an activity of the user 101.

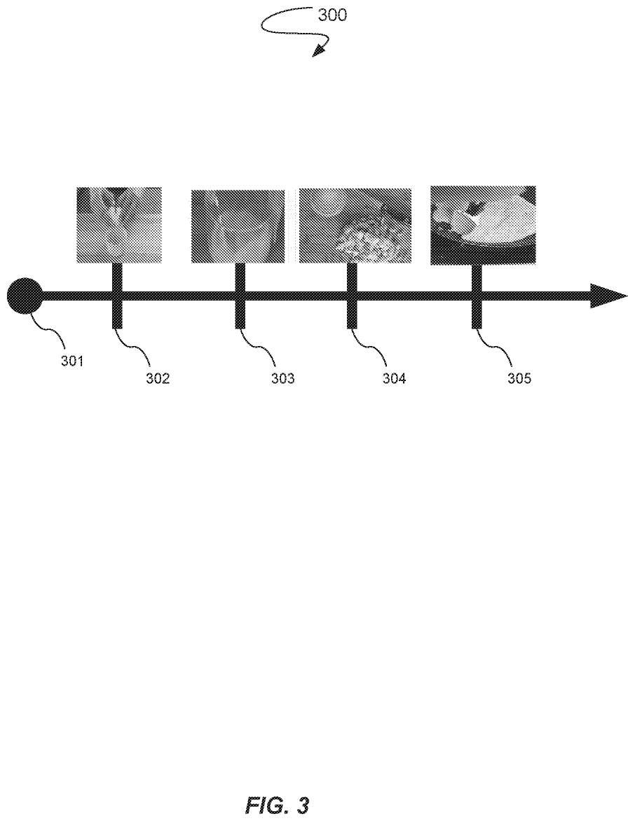

FIG. 3 illustrates an example of a timeline 300 of tutorial video. For instance, the wearable device 102 illustrated in FIG. 1 may capture images of the user 101 that the content selection device 103 determines matches to video segments for cooking an omelet. The AI system 107 then paces various video segments of the same video or different videos based upon data received from the wearable device 102 to coordinate playback of the various video segments based upon the current state of user activity. For example, the AI system 107 may determine if the current user activity corresponds to timeline point 302 of cracking eggs, timeline point 303 of mixing eggs, timeline point 304 of slicing onions and vegetables, or timeline point 305 of cooking the omelet in a pan. Based upon the detected user activity, the AI system 107 automatically plays the content segment corresponding to the detected user activity. The AI system 107 may play the content segments in a different order than the timeline or skip certain content segments depending on the state of the user activity. As a result, the user 101 is able to learn through a tutorial in a manner that is not disruptive.

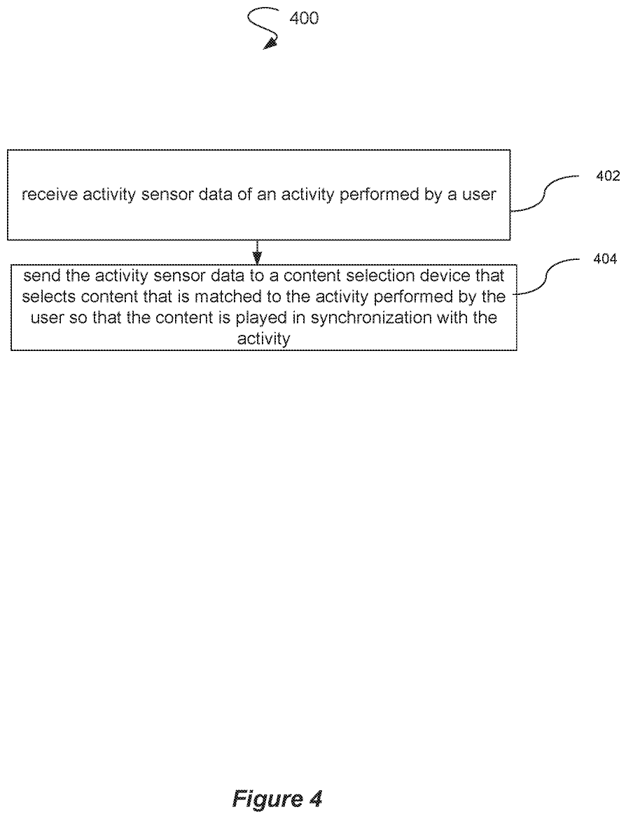

FIG. 4 illustrates a process 400 that is utilized by the smart wearable device 102 to obtain data. At a process block 402, the process 400 receives activity sensor data of an activity performed by the user 101. Further, at a process block 404, the process 400 sends activity sensor data to a content selection device 103 that selects content that is matched to the activity performed by the user so that the content is played in synchronization with the activity.

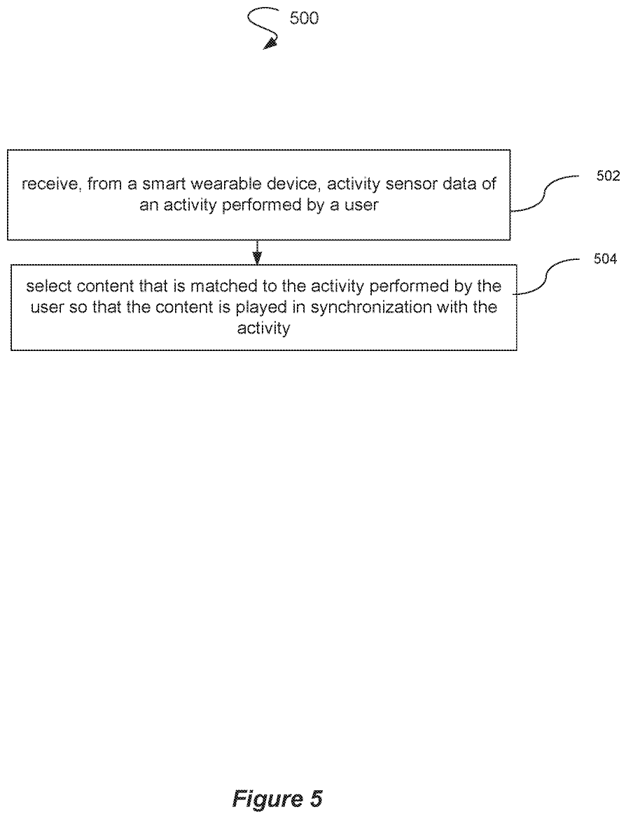

FIG. 5 illustrates a process 500 that is utilized by the content selection device 103 to select content. At a process block 502, the process 500 receives, from the smart wearable device 102, activity sensor data of an activity performed by the user 101. Further, at a process block 504, the process 500 selects content that is matched to the activity performed by the user 101 so that the content is played in synchronization with the activity.

The processes described herein may be implemented by the processor 201 illustrated in FIG. 2. Such a processor will execute instructions, either at the assembly, compiled or machine-level, to perform the processes. Those instructions can be written by one of ordinary skill in the art following the description of the figures corresponding to the processes and stored or transmitted on a computer readable medium such as a computer readable storage device. The instructions may also be created using source code or any other known computer-aided design tool. A computer readable medium may be any medium capable of carrying those instructions and include a CD-ROM, DVD, magnetic or other optical disc, tape, silicon memory, e.g., removable, non-removable, volatile or non-volatile, packetized or non-packetized data through wireline or wireless transmissions locally or remotely through a network. A computer is herein intended to include any device that has a general, multi-purpose or single purpose processor as described above.

The use of “and/or” and “at least one of” (for example, in the cases of “A and/or B” and “at least one of A and B”) is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as listed.

It is understood that the processes, systems, apparatuses, and computer program products described herein may also be applied in other types of processes, systems, apparatuses, and computer program products. Those skilled in the art will appreciate that the various adaptations and modifications of the embodiments of the processes, systems, apparatuses, and computer program products described herein may be configured without departing from the scope and spirit of the present processes and systems. Therefore, it is to be understood that, within the scope of the appended claims, the present processes, systems, apparatuses, and compute program products may be practiced other than as specifically described herein.

1. A smart wearable apparatus comprising:
a processor; and
a memory having a set of instructions that when executed by the processor causes the smart wearable apparatus to:
receive activity sensor data of an activity performed by a user; and
send the activity sensor data to a content selection device that selects content that is matched to the activity performed by the user so that the content is played in synchronization with the activity; wherein the selected content includes a video portion having a resolution adjusted by the content selection device based on at least one of the activity performed by the user and the content to be played.

2. The smart wearable apparatus of claim 1, wherein the content selection device performs the matching of the content to the activity.

3. The smart wearable apparatus of claim 1, wherein a server performs the matching of the content to the activity based upon a query received from the content selection device.

4. The smart wearable apparatus of claim 1, wherein the smart wearable apparatus is further caused to detect a state of the activity and send the state of the activity to a content rendering device that renders the content in synchronization with the activity if the state of the activity corresponds to the content.

5. The smart wearable apparatus of claim 1, wherein the smart wearable apparatus is further caused to detect a state of the activity and send the state of the activity to an artificial intelligence system that determines if the content is rendered based upon a pace of the activity with respect to the content.

6. The smart wearable apparatus of claim 5, wherein the artificial intelligence system generates one or more recommendations based upon the state of the activity.

7. A method comprising:
receiving activity sensor data of an activity performed by a user; and
sending the activity sensor data to a content selection device that selects content that is matched to the activity performed by the user so that the content is played in synchronization with the activity; wherein the selected content includes a video portion having a resolution adjusted by the content selection device based on at least one of the activity performed by the user and the content to be played.

8. The method of claim 7, wherein the content selection device performs the matching of the content to the activity.

9. The method of claim 7, wherein a server performs the matching of the content to the activity based upon a query received from the content selection device.

10. The method of claim 7, further comprising detecting a state of the activity and sending the state of the activity to a content rendering device that renders the content in synchronization with the activity if the state of the activity corresponds to the content.

11. The method of claim 7, further comprising detecting a state of the activity and sending the state of the activity to an artificial intelligence system that determines if the content is rendered based upon a pace of the activity with respect to the content.

12. The method of claim 7, further comprising generating one or more recommendations based upon the state of the activity.

13. A content selection device comprising:
a processor; and
a memory having a set of instructions that when executed by the processor causes the content selection device to:
receive, from a smart wearable device, activity sensor data of an activity performed by a user; and
select content that is matched to the activity performed by the user so that the content is played in synchronization with the activity; wherein the selected content includes a video portion having a resolution adjusted by the content selection device based on at least one of the activity performed by the user and the content to be played.

14. The content selection device of claim 13, wherein the content selection device is further caused to perform the matching of the content to the activity.

15. The content selection device of claim 13, wherein a server (104) performs the matching of the content to the activity based upon a query received from the content selection device.

16. The content selection device of claim 13, further comprising a content rendering device that renders the content in synchronization with the activity if a state of the activity corresponds to the content.

17. The content selection device of claim 13, further comprising an artificial intelligence system that determines if the content is rendered based upon a pace of the activity with respect to the content.

18. The content selection device of claim 13, wherein the artificial intelligence system generates one or more recommendations based upon a state of the activity.

19. (canceled)

20. (canceled)

21. (canceled)

22. (canceled)

23. (canceled)

24. (canceled)

25. A non-transitory computer-readable medium comprising instructions which, when executed by a computer, cause the computer to carry out the method of claim 7.
